(19) United States
(12) Patent Application Publication
(10) Pub. No.: US 2026/0288065 A1
(43) Pub. Date: Sep. 24, 2026

(54) DEVICE FOR DISPLAYING A POINT IN TIME

(71) Applicant: QLOCKTWO LICENSE GMBH, Schwäbisch Gmünd (DE)

(72) Inventors: Andreas FUNK, Schwäbisch Gmünd (DE); Marco BIEGERT, Schwäbisch Gmünd (DE)

(21) Appl. No.: 19/143,241

(22) PCT Filed: Jun. 20, 2023
(86) PCT No.: PCT/EP2023/066558

§ 371 Date: Jun. 25, 2025

(30) Foreign Application Priority Data
Dec. 18, 2022 (EP) 22216958.3

(51) Int. Cl. G04B 19/02; G04B 19/08; G04B 19/257; G04B 45/00

(52) U.S. Cl. CPC G04B 19/02; G04B 19/087; G04B 19/2575; G04B 19/2578; G04B 45/0007

(57) ABSTRACT

A device for displaying a point in time that is indicated in a shorter time unit and a longer time unit is described. The device includes a track forming a closed ring and having a plurality of loops. The track is mounted for rotation around an axis of rotation so that it can be set in rotating motion. The device also includes a marking which is movably guided along the track and passes from one of the loops into an adjacent loop when the track completes a full circle about the axis of rotation. The loop in which the marking is arranged displays the longer time unit of the point in time and the rotational position of this loop displays the shorter time unit of the point in time.

The invention relates to a device for displaying a point in time, that is indicated in a shorter time unit and a longer time unit. In particular, the point in time can be a clock time, for example indicated in hours and minutes, or a calendar date, for example indicated in months and days.

Corresponding clocks and calendars, respectively, are known in countless different designs. In addition to digital displays that show the two pieces of information (e.g. hour and minute or, respectively, month and day) as numbers, there are classic dials with hour and minute hands as well as numerical or pointer displays of the date. In such displays, there are usually separate display elements for each of the two pieces of information, each comprising a fixed and a movable element. For example, there are dials with two windows, behind which two circular disks or rollers with number indicators for month and day are moved, or fixed scales with two moving pointers pointing to them.

From the publication EP 0 813 124A1 , a watch has become known, the dial of which has a curved groove in the form of an epicycloid. Behind the dial there is a gear unit with a sun gear and a planet gear, which has a pin that is offset laterally to the axis of the planet wheel, engages in the groove, and is visible from the front through the dial. The pin is moved along the groove by a drive of the gear unit. The progression of the pin along the groove displays the clock time.

### SUMMARY

Based on this, the object of the invention is to provide a device for displaying a point in time that meets high design demands with a simple movement sequence.

This object is achieved by the device with the features of claim 1. Advantageous embodiments are indicated in the sub-claims.

The device is used to display a point in time that is indicated in a shorter time unit and a longer time unit. The device has the following:
a track forming a closed ring and having a plurality of loops, wherein the track is mounted for rotation around an axis of rotation so that it can be set in rotating motion, and
a marking which is movably guided along the track and passes from one of the loops into an adjacent loop when the track completes a full circle about the axis of rotation, wherein the loop in which the marking is arranged displays the longer time unit of the point in time and the rotational position of this loop or the rotational position of the marking located in this loop displays the shorter time unit of the point in time.

The track forms a closed ring, which can basically have any geometry. The track can be arranged in a plane or approximately in a plane. The track can have a circular basic shape. The track can be designed in a curved shape so that it is not or only approximately arranged in a plane.

As the track rotates around the axis of rotation, the marking moves along the track, first along the loop in which it is currently located, then, upon completing a full circle around the axis of rotation, into an adjacent loop, further along this loop, into the next loop adjacent to this loop, and so on until the marking returns to its starting point and the process starts again as the rotational movement progresses.

The loops can all have the same geometry, resulting in a particularly harmonic design. However, it is also possible to use loops of different shapes and/or sizes, for example to make loops for certain point in times (e.g. for the hours 3, 6, 9 and 12 o'clock) stand out visually compared to the loops for the other point in times. The number of loops corresponds to the number of longer time units to be displayed.

In the device, the rotation of the track corresponds to the passage of time. If the track is rotated further from a certain starting point by a certain angle (wherein the angle can be one or more full circles or only parts of a full circle), the position of the marking along the track indicates how far the track has been rotated and thus the point in time corresponding to this rotation. Due to the special geometry of the track with the loops, the marking moves “one loop further” for each full circle of the rotational movement. Therefore, the loop in which the marking is arranged at a certain point in time provides information about the full circles completed since the starting point. The rotational position of this loop or the rotational position of the marking arranged in this loop displays the shorter time unit of the point in time. The rotational position of the marking arranged in the loop refers to the position of the marking in relation to the rotational movement of the track, not to any rotation of the marking itself around its own axis that may also be possible. If, for example, the device is a calendar that displays the month as the longer time unit and the calendar day of this month as the shorter time unit, one full circle of the track corresponds to the passage of one month. As a result of the rotation around a full circle, the marking moves accordingly one loop further, starting from the loop it was in at the beginning, so that the displayed point in time advances by one month. The rotational position of the loop follows the rotational movement and can advance a fraction of a full circle for each shorter time unit through corresponding selection of the rotational speed, so that the shorter time unit of the point in time can always be read from the rotational position of the loop or, respectively, from the rotational position of the marking arranged in this loop. In the example of the calendar illustrated here, a rotational movement by a certain fraction of a full circle, for example 360° divided by 31 calendar days, corresponds to the passage of one day.

It is not necessary that the track rotates around the axis of rotation at a constant speed. For example, the device can be used as a desk calendar in which the rotation is carried out manually so that the rotational position of the track is manually advanced by one day each day. Therefore, a scale on which the shorter time unit of the point in time in particular is read off can be designed largely freely.

Overall, the device is an aesthetically pleasing object that represents the progress of time in an interesting way.

In one embodiment, the device has a drive that sets the track in rotating motion around the axis of rotation so that the track describes a full circle in one of the longer time units. The drive can be a stepper motor or another electric drive, for example. It can drive the track at a constant speed. However, it is also possible to vary the rotational speed. In particular, a constant speed can be selected within one of the longer time units so that the rotational position of the track (including the loop in which the marking is currently located) advances by the same angle in each of the smaller time units. If the last shorter time unit is exceeded within one of the current longer time units, the track can be driven at a different rotational speed, in particular a higher one. This allows the marking to move from the relevant loop to the adjacent loop in a short time when the full circle is completed or respectively, at the end of the longer time unit. As a result, this process runs particularly smoothly and at a precisely defined point in time. In the calendar example, this applies in particular to exceeding the monthly limit, for example at the end of March 31. At this point in time, a rotational movement can be carried out at a relatively high speed in order to cause the display to “jump” quickly to April 1.

In one embodiment, the track is arranged in a vertical plane and the axis of rotation is arranged horizontally. In this case, the device has a particularly clear design that is well suited for wall mounting or upright positioning. Gravity can optionally be used to move the marking along the track optimally (see below). In principle, however, it is neither necessary to arrange the track in a plane nor to arrange the axis of rotation horizontally. In particular, the axis of rotation can be inclined. A prerequisite for the proper functioning of the device is that the track with the loops is shaped in such a way that the marking reaches the adjacent loop when a full circle is completed.

In one embodiment, the track describes a curve in the region of each loop, the angle of which is 360° minus 360° divided by the number of existing loops. The curve can be circular along the spanned angle, but can also have a geometry that deviates from a circular shape, for example elliptical or oval.

In one embodiment, the loops are arranged on a circle and are connected to each other by intermediate pieces of the track and each have an inlet and an outlet, so that each outlet is connected to the inlet of an adjacent loop by one of the intermediate pieces. The intermediate pieces can be straight or have a curvature. The fact that the loops are arranged in a circle does not refer to the shape of the individual loops, but to the arrangement of the loops overall. For example, the center points or the points furthest in or out of the individual loops can be arranged on a circle. The inlet and outlet of a loop can be arranged adjacent to each other, in particular offset from each other in the direction of the axis of rotation. In any case, the inlets and outlets of the loops and the geometry of the loops are designed in such a way that the marking travels from the outlet of one loop via the associated intermediate piece to the inlet of the next loop, so that a smooth transition from one loop to the next loop is guaranteed.

In one embodiment, the intermediate pieces are arranged on a circle, wherein the loops point inwards or outwards from this circle. If they themselves have a curvature, the intermediate pieces can follow an exact circular path, but they can also be arranged only approximately on an imaginary circle. The latter applies, for example, if the intermediate pieces themselves have a geometry that deviates from the circular path, e.g. are straight or straight in portions. If the inlets and outlets of the loops are arranged at the same point or closely adjacent to each other in relation to the rotational movement, the basic shape of the track is essentially determined by the arrangement of the intermediate pieces. Depending on whether the loops point inwards or outwards, the approximate circular shape described by the intermediate pieces can represent an inner or outer boundary of the track. In the case of outward-pointing loops, the intermediate pieces can represent an inner boundary of the track. In this case, the inlets and outlets of the loops are located in particular at the inner boundary of the track and the transition of the marking from one loop to the adjacent loop always takes place in particular when the current loop is approximately at the highest point. In the case of inward-pointing loops, the intermediate pieces can represent an outer boundary of the track. In this case, the inlets and outlets of the loops are located in particular at the outer boundary of the track and the transition of the marking from one loop to the adjacent loop always takes place in particular when the current loop is approximately at the lowest point.

In one embodiment, the track has a stop element at the outlet of a loop, which stop element is designed in such a way that the marking stops when it reaches the stop element and only continues to move when the track has rotated further by a defined angle. For example, the track may have an elevation or a hump that the marking has to overcome. This measure allows the point in time at which the marking “jumps” from each loop to the adjacent loop to be specified exactly by controlling the rotational movement of the track accordingly.

In one embodiment, the marking moves freely along the track due to gravity, so that it is always located at a local low point on the track. The local low point usually corresponds to the lowest point of the loop at which the marking is currently located. In this embodiment, an intermediate piece that connects two adjacent loops is never or only for a short time interval the local low point, namely while the marking is moving towards the next loop. Moving the marking by means of gravity in this way is particularly easy and interesting and entertaining for a viewer to observe. In principle, however, other options are also possible for moving the marking along the track, for example using a separate drive and/or elastic and/or magnetic forces.

In one embodiment, the marking has a body that rolls on the track, wherein the track has a geometry that is adapted to the body and guides the body laterally. For example, the marking can be a ball or a roller or a more complicated object with wheels. In particular, the track can be designed as a channel or groove or rail to enable the body to roll on the track while being guided laterally. A track that is well suited for this purpose can have two wires arranged at a uniform horizontal distance from each other, wherein the distance can be dimensioned in such a way that the body arranged between the two wires does not fall through and is guided laterally by the two wires. The use of a ball in particular impresses with its simplicity and aesthetic clarity. At the same time, a ball can move along the track with minimal resistance and without issue even with manufacturing tolerances.

In one embodiment, the marking has a body that slides along the track. A sliding movement of the body along the track enabled in this way can be carried out, for example, with a body that has a through-hole, such as a ball or a cube. The track can have a wire or a similar guide element that runs through the through-opening. This solution is also particularly simple and is characterized by the fact that the body is held securely on the track and therefore cannot be lost.

In one embodiment, the device has a scale, on which the rotational position of the loop in which the marking is arranged or, respectively, the rotational position of the marking arranged in this loop, can be read off, wherein the scale has sectors with a center angle which corresponds to the angle of rotation representing one of the shorter time units. The scale makes it particularly easy to read off the rotational position of the track, which is important for reading off the shorter time unit.

In one embodiment, the scale has a starting point and an end point and a free sector in between, the center angle of which corresponds to the angle spanned by two adjacent loops with an axis of rotation of the track. A slightly smaller or larger dimensioning of the center angle of the free sector is included. In any case, the free sector offers sufficient clearance for the marking to reach the adjacent loop. The marking is then automatically located approximately at the starting point of the scale. In the example of a calendar with a ball as a marking, for example, this means that at the end of March 31, the ball passes over the free sector along the intermediate piece and enters the adjacent loop for the following month of April, which at the “changeover point” is approximately at the starting point of the scale, i.e. on the first calendar day.

In one embodiment, the point in time is a clock time, the shorter time unit is a minute and the longer time unit is an hour. In this case, the device serves as a clock that displays the point in time in minutes and hours. For example, 12 or 24 loops can be selected for use so that the clock time is displayed accordingly in a 12 or 24-hour format.

In one embodiment, the point in time is a calendar date, the shorter time unit is a day and the longer time unit is a month. In this case, the device comprises 12 loops for the months. It is also conceivable to use 52 loops to display the calendar week as the longer time unit, in particular with the weekday (Monday, Tuesday, etc.) as the shorter time unit.

In one embodiment, the point in time is a calendar date, the shorter time unit is a month and the longer time unit is a year. In this case, for example, 12 loops can be used for 12 years, corresponding to the signs of the zodiac on which certain Chinese calendars are based, for example.

In one embodiment, the track has a label that can be used to assign a specific element of the longer time unit to each loop, for example a specific hour, a specific month or a specific year. The label can have a single labeling element or several labeling elements. Each labeling element can be, for example, a character, a color marking or a special geometry or decoration of the track. The labeling elements move with the track. They can be attached to the track itself, in particular to the loops of the track, or to another element that moves with the track. For example, when used as a calendar, where the elements of the longer time unit are the calendar months, the loop representing the month of January can be labeled as such. This also results in an assignment of the next loop to the following month of February, etc. If several labeling elements are used, several or all loops can be provided with a labeling element. For example, if the device is a clock and the longer time unit is the hour, only the loops representing the elements 3 o'clock, 6 o'clock, 9 o'clock and 12 o'clock, for example, can be marked, for example with Roman or Arabic numerals.

### BRIEF DESCRIPTION OF THE DRAWINGS

The invention is explained in more detail below using exemplary embodiments. In the figures:

FIG. 1 shows a device with a track and a marking in a schematic representation,

FIG. 2 shows a plan view of the device on which FIG. 1 is based,

FIG. 3 shows an enlarged section of FIG. 1,

FIG. 4 shows a section of another device with a loop and a ball arranged therein,

FIG. 5 shows another device in a view from the front, and

FIG. 6 shows an enlarged view of a section of the device shown in FIG. 5.

### DETAILED DESCRIPTION

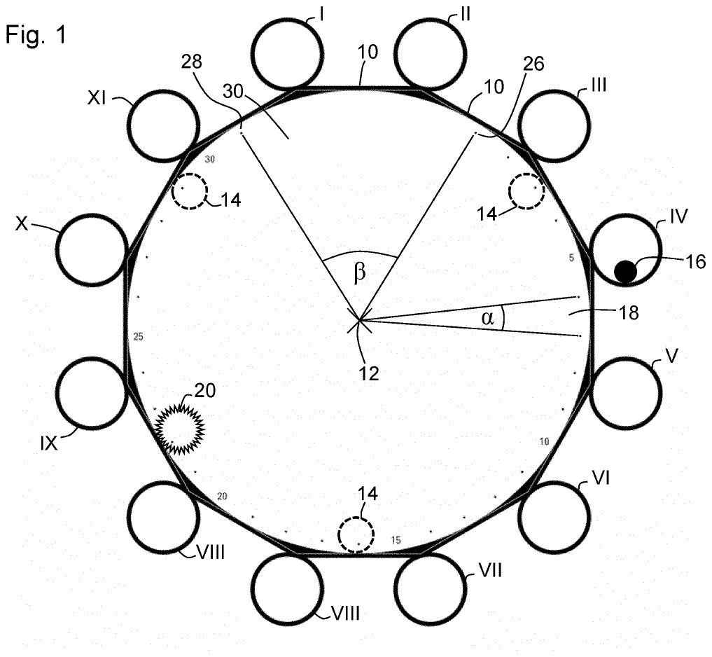

The device from FIG. 1 serves as a calendar for displaying the date, wherein the longer time unit indicates the month and the shorter time unit indicates the day. For this reason, the schematically depicted track comprises twelve loops, which are labeled with the Roman reference signs I to XII and represent the calendar months from January to December. Loops I to XII are each roughly circular and arranged with their centers on a circle. Loops I to XII all have the same shape and size and are connected to each other by twelve intermediate pieces 10. The track, which comprises the intermediate pieces 10 and the loops I to XII, is located approximately in a vertically arranged plane and is about an axis of rotation 12, which is arranged horizontally (perpendicular to the drawing plane) and is located in the center of the track.

The track is rotatably mounted on three rollers 14, which rest against an inner side of the track, so that the track rotates about the (imaginary) axis of rotation 12. A marking in the form of a ball 16 is arranged in loop IV. This displays that the current calendar month is April. A scale with 31 dots corresponding to 31 calendar days is located inside the track. The calendar days 5, 10, 15, 20, 25 and 30 have no dots, but are numbered accordingly. Each pair of two adjacent scale dots forms a sector 18 with a center angle α.

The device has a drive 20, which is only indicated schematically, which in the example engages on the inner side of the track and rotates the track around the axis of rotation 12. The drive 20 is controlled in such a way that the rotational movement of the track passes over the center angle α of a sector within one day, i.e. within one of the shorter time units. As a result, the track and thus in particular loop IV, in which the ball 16 is located, moves further on the scale by one calendar day within 24 hours.

If the ball 16 or, respectively, the loop in which the ball 16 is currently located is on the last day of a calendar month, for example on April 30, the drive 20 is activated in such a way that the track continues to move around the axis of rotation 12 until the loop IV is finally so far up that the ball 16 leaves this loop IV and enters the loop V along the intermediate piece 10 leading to loop V. The loop V is then located at the scale marking for the first calendar day or, respectively, the track is moved forward to this point so that the calendar displays May 1. In this way, the marking 16 moves to the adjacent loop upon the completion of each full circle, so that the displayed point in time advances by one month in each case.

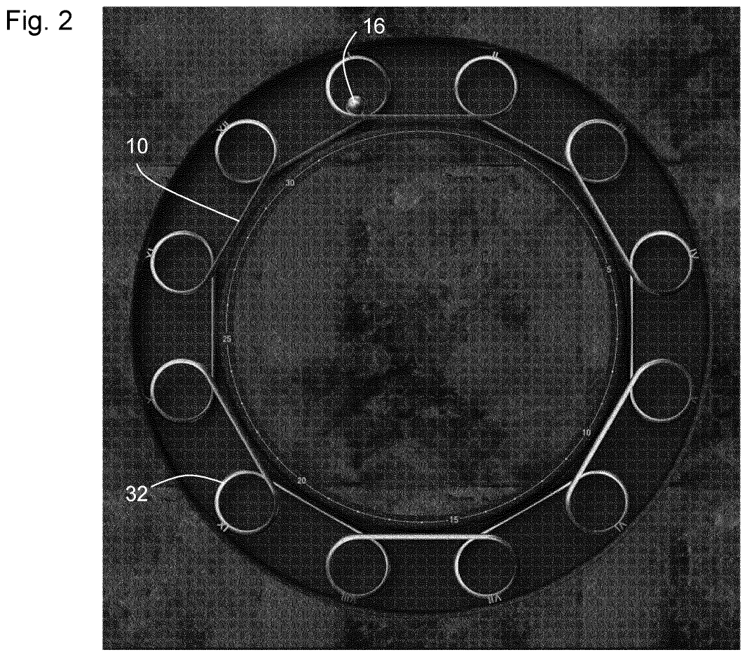

FIG. 2 shows the device shown schematically in FIG. 1 in a specific embodiment, in which a ball 16 serves as the marking and the track is formed by a metal profile 32, which forms the loops I to XII and intermediate pieces 10.

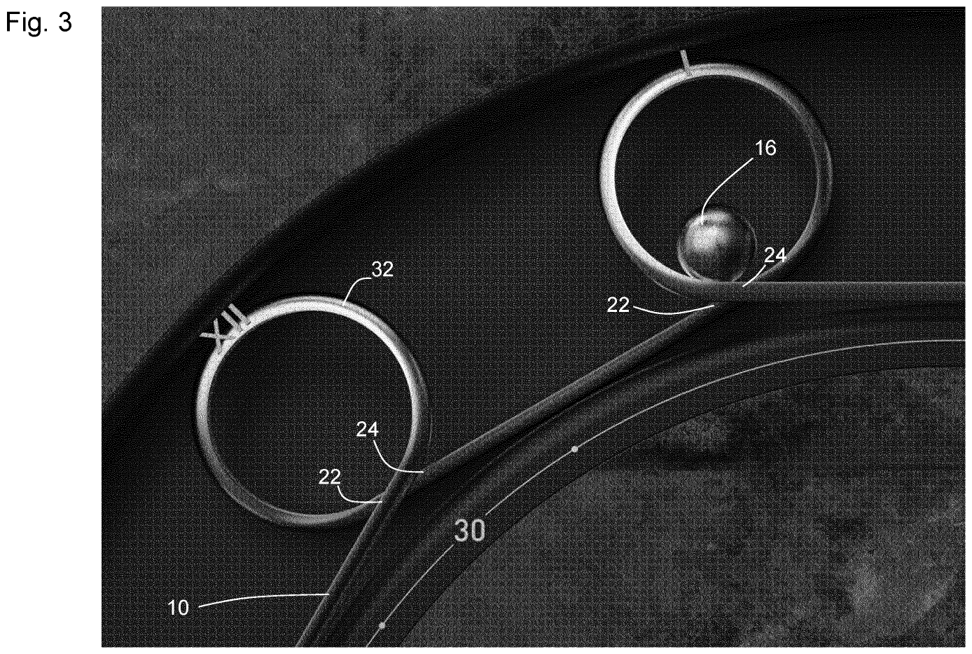

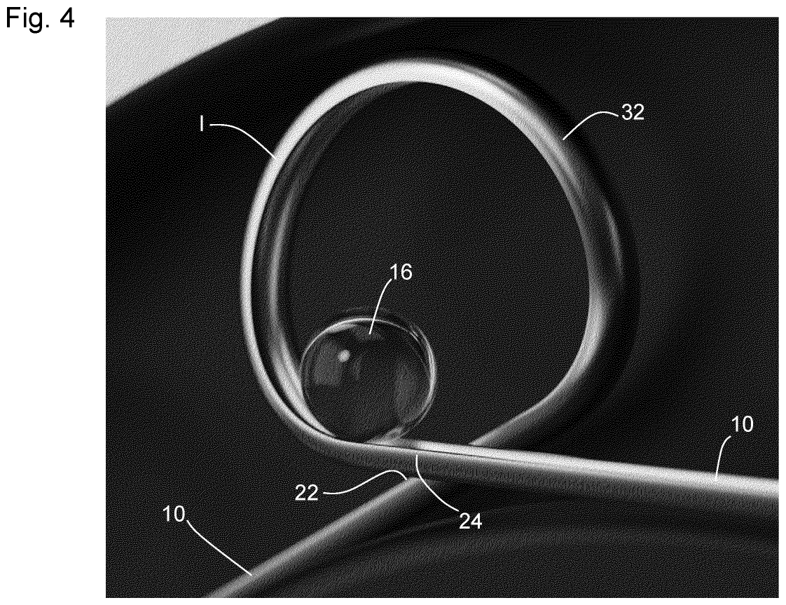

The enlarged representations in FIGS. 3 and 4 best show the design of the individual loops I to XII. The metal profile 32 forms a channel in which the ball 16 is guided. Each loop I to XII has an inlet 22, which is located at a specific position on the metal profile, and an outlet 24 arranged at the end of the applicable loop. The inlet 22 and outlet 24 are arranged adjacent to each other and are located at approximately the same position in the direction of the rotational movement of the track. The lateral distance between the inlet 22 and outlet 24 is sufficiently large so that the ball 16 can pass the “crossing point.” The ball 16 rolls along the track and is guided laterally by the channel-shaped contour of the metal profile 32.

FIGS. 2 and 3 show that the track has a label: Each of the loops I to XII has a Roman numeral I to XII attached to the respective loops as a labeling element, which can be used to assign the corresponding calendar month to each loop.

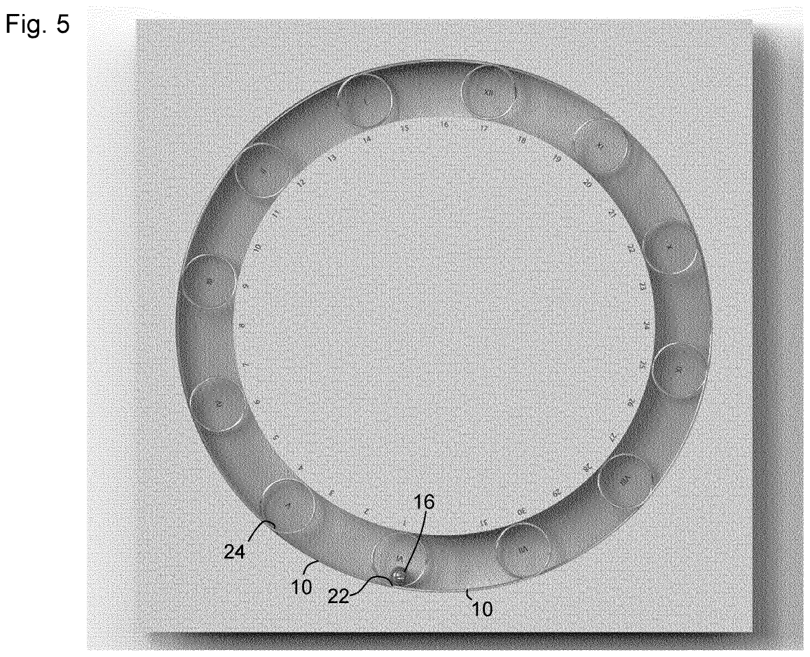

FIG. 5 shows another device, also serving as a calendar, with a track which, like the one in FIGS. 1 and 2, has twelve loops I to XII and twelve intermediate pieces 10. The loops I to XII are arranged on a circle, as are the intermediate pieces 10. In contrast to FIGS. 1 and 2, the loops I to XII point inwards here and the intermediate pieces 10 form an outer rather than an inner boundary of the track. As in FIGS. 1 and 2, the marking is in the form of a ball 16. In the rotational position of the track shown, the ball 16 is in the loop VIII, which displays the month of July. The rotational position of the ball 16 or, respectively, of the marking “VIII” of the current loop is located close to the number 1 on the scale from 1 to 31, which is fixed along the inner side of the track and corresponds to the days. The device therefore displays the date August 1.

On the previous day, July 31, the ball 16 was still located in the loop VII, which is shown to the left of the loop VIII and which was arranged near the scale marking 31. When this was located approximately at its lowest point during the rotational movement of the track, the ball 16 rolled from the outlet 24 of loop VII onto the adjacent intermediate piece 10 and then further on the intermediate piece 10 to the inlet 22 of the loop VIII, where it is shown in FIG. 5. This process corresponds to the transition from July 31 to August 1.

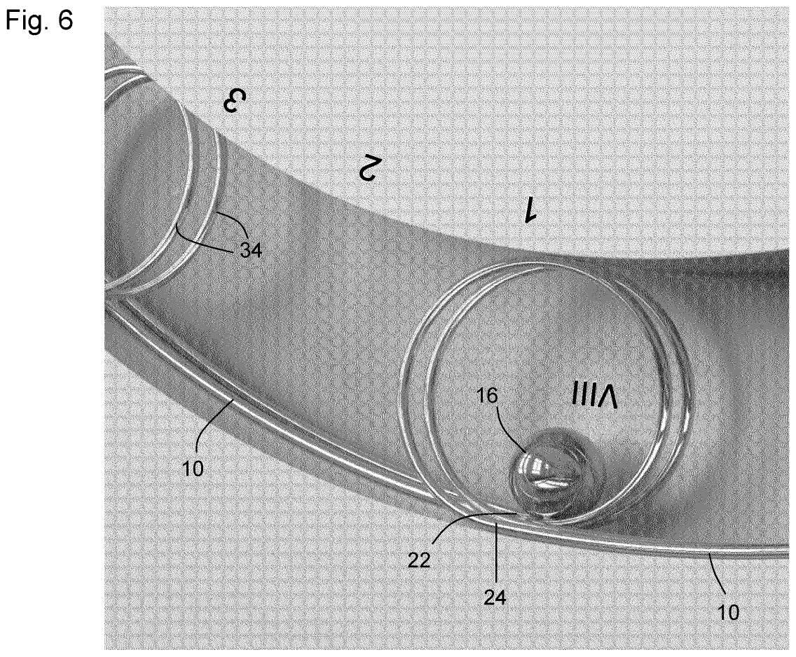

In the enlarged view in FIG. 6, the arrangement of the ball at approximately the inlet 22 of the loop VIII is once again clearly recognizable. The track has two wires 34, which are arranged along the entire track at a uniform horizontal distance from each other. The distance is approximately half the diameter of the ball 16, so that the ball cannot fall between the wires 34 and is guided laterally along the track by the wires 34.

Also recognizable is the arrangement of the labeling elements on the track, which are again designed as Roman numerals I to XII. In this example, the track is connected to a component (which is ring-shaped in the example shown) that is arranged on the side of the track facing away from the viewer and moves with the track. The labeling elements are located on this component, each in the region of one of the loops I to XII, in the example within one of the loops I to XII.

### List of Reference Signs

I, II, III, IV, . . . , XII Loop
10 Intermediate piece
12 Axis of rotation
14 Roller
16 Bal
18 Sector
20 Drive
22 Inlet
24 Outlet
26 Starting point
28 End point
30 Free sector
32 Metal profile
34 Wire
α Center angle
β Center angle

1. A device for displaying a point in time that is indicated in a shorter time unit and a longer time unit, wherein the device has the following:
a track forming a closed ring and having a plurality of loops, wherein the track is mounted for rotation around an axis of rotation so that it can be set in rotating motion, and
a marking which is movably guided along the track and passes from one of the loops into an adjacent loop when the track completes a full circle around the axis of rotation, wherein
the loop in which the marking is arranged at a certain point in time provides information about the full circles completed since a starting point and displays the longer time unit of the point in time, and
the rotational position of this loop or the rotational position of the marking arranged in this loop indicates the shorter time unit of the point in time.

2. The device according to claim 1, wherein the device has a drive which sets the track in rotating motion around the axis of rotation so that the track describes a full circle in one of the longer time units.

3. The device according to claim 1, wherein the track is arranged in a vertical plane and the axis of rotation is arranged horizontally.

4. The device according to claim 1, wherein the track describes a curve in the region of each loop, the angle of which is 360° minus 360° divided by the number of existing loops.

5. The device according to claim 1, wherein the loops are arranged on a circle and are connected to one another by intermediate pieces of the track and each have an inlet and an outlet, so that each outlet is connected to the inlet of an adjacent loop by one of the intermediate pieces.

6. The device according to claim 5, wherein the intermediate pieces are arranged on a circle, wherein the loops point inwards or outwards from this circle.

7. The device according to claim 1, wherein the track has a stop element at the outlet of a loop, which stop element is designed in such a way that the marking stops when it reaches the stop element and only continues to move when the track has rotated further by a defined angle.

8. The device according to claim 1, wherein the marking moves freely along the track due to gravity, so that it is always located at a local low point of the track.

9. The device according to claim 1, wherein the marking has a body that rolls on the track, wherein the track has a geometry that is adapted to the body and guides the body laterally.

10. The device according to claim 1, wherein the marking has a body that slides along the track.

11. The device according to claim 1, wherein the device has a scale, on which the rotational position of the loop in which the marking is arranged or, respectively, the rotational position of the marking arranged in this loop, can be read off, wherein the scale has sectors with a center angle (α) which corresponds to the angle of rotation representing one of the shorter time units.

12. The device according to claim 11, wherein the scale has a starting point and an end point and between them a free sector, the center angle (β) of which corresponds to the angle spanned by two adjacent loops with an axis of rotation of the track.

13. The device according to claim 1, wherein the point in time is a clock time, the shorter time unit is a minute and the longer time unit is an hour.

14. The device according to claim 1, wherein the point in time is a calendar date, the shorter time unit is a day and the longer time unit is a month.

15. The device according to claim 1, wherein the point in time is a calendar date, the shorter time unit is a month and the longer time unit is a year.

16. The device according to claim 1, wherein the track has a label that can be used to assign a specific element of the longer time unit to each loop, for example a specific hour, a specific month or a specific year.

17. A device for displaying a point in time that is indicated in a shorter time unit and a longer time unit, wherein the device has the following:
a track forming a closed ring and having a plurality of loops, wherein the track is mounted for rotation around an axis of rotation so that it can be set in rotating motion, and
a marking having a body which rolls along the track and passes from one of the loops into an adjacent loop when the track completes a full circle around the axis of rotation, wherein
the track has a geometry that is adapted to the body and guides the body laterally,
the loop in which the marking is arranged at a certain point in time provides information about the full circles completed since a starting point and displays the longer time unit of the point in time, and
the rotational position of this loop or the rotational position of the marking arranged in this loop indicates the shorter time unit of the point in time.

18. A device for displaying a calendar date that is indicated in a day and a month, wherein the device has the following:
a track forming a closed ring and having a plurality of loops, wherein the track is mounted for rotation around an axis of rotation so that it can be set in rotating motion, and
a marking which is movably guided along the track and passes from one of the loops into an adjacent loop when the track completes a full circle around the axis of rotation, wherein
the loop in which the marking is arranged at a certain calendar date provides information about the full circles completed since a starting calendar date and displays the month of the calendar date,
the rotational position of this loop or the rotational position of the marking arranged in this loop indicates the day of the calendar date, and
the track has a label that can be used to assign a specific element of the month to each loop.
